(19) United States
(12) Patent Application Publication
(10) Pub. No.: US 2023/0383372 A1
(43) Pub. Date: Nov. 30, 2023

(54) Method for Forming Vehicle Component

(71) Applicant: Ford Global Technologies, LLC, Dearborn, MI (US)

(72) Inventors: Constantin Chiriac, Windsor (CA); Raj Sohmshetty, Canton, MI (US); S. George Luckey, JR., Dearborn, MI (US); David Scott Ruhno, Canton, MI (US); Ilya Popov, Aachen NRW (DE)

(21) Appl. No.: 18/304,931

(22) Filed: Apr. 21, 2023

Related U.S. Application Data
(63) Continuation of application No. 15/903,707, filed on Feb. 23, 2018, now abandoned.

(51) Int. Cl. C21D 8/00; B21D 22/02; B32B 15/01

(52) U.S. Cl. CPC C21D 8/005; B21D 22/02; B32B 15/012

(57) ABSTRACT

A method for forming a vehicle component is provided. The method may include heating a blank of 36MnB5 in a furnace to an austenitization temperature, stamping the blank with a die assembly to form a vehicle component and change a microstructure of the blank from austenite to martensite, and responsive to a temperature of the vehicle component being at or below 130° C., removing the vehicle component from the die assembly such that the vehicle component has a yield strength equal to or greater than 1400 MPa. The blank may be retained within the die assembly for a quench time of between five and eleven seconds following the stamping. The method may further include thermo-stabilizing a surface of the die assembly to a predetermined temperature. The stamping may further include applying a pressure of approximately 10 N/mm² to the blank.

### CROSS-REFERENCE TO RELATED APPLICATION

This application is a continuation of U.S. application Ser. No. 15/903,707, filed Feb. 23, 2018, the disclosure of which is hereby incorporated in its entirety by reference herein.

### TECHNICAL FIELD

This disclosure relates to a method forming vehicle components.

### BACKGROUND

Materials having press-hardened steel grades with higher strength levels are being used in vehicle component formation to meet increased vehicle component strength demands. Some of these materials are alloyed and/or coated. An application of previous forming methods to these materials does not result in a vehicle component having acceptable mechanical properties.

### SUMMARY

A method for forming a vehicle component includes heating a blank of 36MnB5 in a furnace to an austenitization temperature, stamping the blank with a die assembly to form a vehicle component and change a microstructure of the blank from austenite to martensite, and responsive to a temperature of the vehicle component being at or below 130° C., removing the vehicle component from the die assembly such that the vehicle component has a yield strength equal to or greater than 1400 MPa. The blank may be micro-alloyed with Niobium, Titanium, Molybdenum, and Chromium and coated with AlSi10Fe3. The blank may be retained within the die assembly for a quench time of between five and eleven seconds following the stamping. The method may further include thermo-stabilizing a surface of the die assembly to a predetermined temperature. The predetermined temperature may be approximately 100° C. The stamping may further include applying a pressure of approximately 10 N/mm² to the blank. The method may further include thermo-stabilizing a surface of the die assembly to 100° C. or less prior to stamping the blank and subjecting the vehicle component to an approximate five second quench time. The blank may be Usibor 2000.

A method for forming a vehicle component includes heating a blank within a furnace, stamping the blank with a die assembly at a contact pressure of approximately 10 N/mm² to form a vehicle component, and removing the vehicle component at or below a temperature of 130° C. The contact pressure and the removal at or below 130° C. results in a martensitic microstructure and a yield strength at or greater than 1400 MPa. The blank may be 36MnB5 micro-alloyed with Niobium, Titanium, Molybdenum, and Chromium and coated with AlSi10Fe3. The blank may be Usibor 2000. The method may further include quenching the vehicle component within the die assembly for a time-period of between five and eleven seconds. The contact pressure of approximately 10 N/mm² applied to the blank may reduce a temperature of the vehicle component to 130° C. or less.

A method for forming a vehicle component includes heating a blank to a predetermined temperature in a furnace, transferring the blank to a die assembly, stamping the blank within the die assembly at a contact pressure of approximately 10 N/mm² to form a vehicle component, quenching the formed vehicle component within the die assembly for a time-period of between five and eleven seconds, and responsive to a temperature of the vehicle component being at or below 130° C., removing the vehicle component from the die assembly such that the vehicle component has a fully martensitic microstructure and a yield strength equal to or greater than 1400 MPa when removed from the die assembly. The method may further include thermo-stabilizing a surface of the die assembly to a predetermined temperature prior to stamping the blank. The predetermined temperature may be approximately 100° C. The surface of the dies assembly may be thermo-stabilized for approximately thirty minutes prior to performing the quenching operation. The blank may have an approximate 1.6 mm thickness. 1416. The blank may be 36MnB5 micro-alloyed with Niobium, Titanium, Molybdenum, and Chromium, and coated with AlSi10Fe3. The blank may be Usibor 2000.

### BRIEF DESCRIPTION OF THE DRAWINGS

FIG. 1 is a diagrammatic view of an example of a portion of a hot stamping process.

FIG. 2 is a flow chart illustrating an example of a method for forming a vehicle component.

FIG. 3 is a graph illustrating an example of a comparison of yield strength and tensile strength for a steel blank subjected to various extraction temperatures.

FIG. 4 is a graph illustrating an example of a comparison of thermos-profiles of a steel blank subjected to various die quench time-periods.

FIG. 5 is a graph illustrating an example of a comparison of thermos-profiles of a steel blank subjected to various pressure applications.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be used in particular applications or implementations.

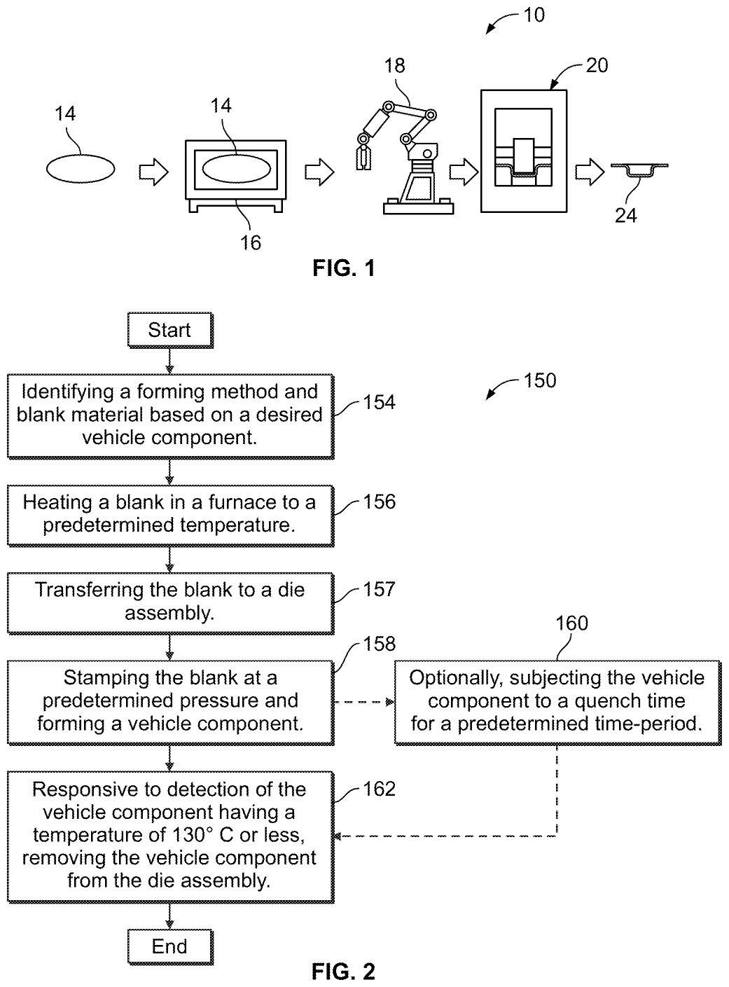

FIG. 1 is a diagrammatic view of an example of a portion of a hot-stamping line that may be used to manufacture a vehicle body component, referred to generally herein as a hot-stamping process 10. Hot-stamping, also known as hot forming or press-hardening, is a process of stamping a blank while the metal is very hot, usually in excess of 600 degrees Celsius, and subsequently quenching the formed blank in a closed die. The hot-stamping process may convert low-strength blanks to high-strength components. For example, the finished component may have a minimum yield strength of approximately 1400 megapascals (MPa) and a minimum tensile strength of approximately 1800 MPa.

In the hot-stamping process 10, a boron steel blank 14 (which may be press-hardenable steel) is placed in a furnace 16 and heated above a phase transformation temperature forming austenite.

The phase transformation temperature is the transformation temperature at which ferrite fully transforms into austenite, sometimes referred to as Ac3. For example, the blank 14 may be heated at 900 to 950 degrees Celsius for a predetermined time in the furnace 16. The bake time and furnace temperature may vary depending on the material of the blank 14 and desired properties of the finished part. After heating, a robotic transfer system 18 may transfer the blank 14, now austenitized, to a die assembly 20. The die assembly 20 stamps the blank 14 into a desired shape while the blank 14 is still hot to form a vehicle component 24 from the blank 14.

The vehicle component 24 may then be quenched while the die assembly 20 is still closed using water or other coolant. For example, the die assembly 20 may include coolant channels located for thermal communication with the vehicle component 24. Quenching is provided at a cooling speed of up to 150 C/s for a predetermined duration at the bottom of a stroke. Quenching at various time-periods may influence a transition of a microstructure of the vehicle component 24. For example, the quenching may change the microstructure of the vehicle component 24 from austenite to martensite. After quenching, the vehicle component 24 may be removed from the die assembly 20 while the component is still hot. The vehicle component 24 may then be cooled, for example, on racks.

A hot-stamping process may provide numerous advantages over other high-strength steel forming methods such as cold-stamping. One advantage of hot-stamping is a reduced spring back and warping of the blank. Hot-stamping also allows complex shapes to be formed in a single stroke of the die to reduce downstream processing and increase efficiency in the manufacturing of the vehicle component from the blank.

Hot-stamped components may be both lightweight and strong. Examples of vehicle components that may be formed by hot-stamping may include: body pillars, rockers, rails, bumpers, intrusion beams, carrier understructure, mounting plates, front tunnels, front and rear bumpers, reinforcement members, and side rails.

FIG. 2 is a flow chart illustrating an example of a method for forming a vehicle component, referred to generally as a method 150. In operation 154, a forming method and blank material are selected based on a desired vehicle component. For example, the desired forming method may be based on targeted mechanical properties for the formed vehicle component. The type of blank material may be selected based on cost and the targeted mechanical properties. One example of a material is Usibor 2000. The Usibor 2000 or other similar material may include 36MnB5 micro-alloyed with Niobium, Titanium, Molybdenum, and Chromium and coated with AlSi10Fe3. Targeted mechanical properties of a vehicle component including the 36MnB5 micro-alloyed and coated may be a minimum yield strength of 1400 MPa, a minimum tensile strength of 1800 MPa, and a minimum total elongation of 6%. 36MnB5 is a press hardenable steel having a composition comprising: manganese greater than zero and up to 1.4 wt. %; silicon greater than zero and up to 0.7 wt. %; carbon greater than zero and up to 0.37 wt. %; and boron greater than zero and up to 0.005 wt. %.

In operation 156, the blank may be inserted into a furnace, such as the furnace 16, for heating to a predetermined temperature to modify a microstructure of the blank. In one example, the blank may be heated to a predetermined temperature corresponding to an austenitization temperature or Ac3 of the blank material and/or 950° C. or less. In operation 157, the now heated blank may be transferred to a die assembly, such as the die assembly 20. It is contemplated that the blank may be transferred from the furnace to a die assembly or the furnace may also include stamping components such that the transfer is not necessary.

In operation 158, the blank may be stamped to form a shape of the desired vehicle component. A predetermined pressure may be applied during the stamping to further assist in increasing a strength of the now formed vehicle component. For example, a contact pressure of approximately 10 N/mm² may be applied to the blank to increase a yield strength of the vehicle component. This contact pressure may also assist in reducing a temperature of the vehicle component prior to extraction from the die assembly.

Optionally, in operation 160, the vehicle component may be subjected to a quench time over a predetermined time-period. The quench time is a predetermined time-period in which the vehicle component is held for cooling within the die assembly. In one example, the predetermined time-period may be between five seconds and eleven seconds. The pressure applied in operation 158 may be held constant throughout the quench time. The die assembly may include additional thermal features to further assist in reducing a temperature of the vehicle component. For example, a surface of the die assembly contacting the blank and/or vehicle component may be thermo-stabilized to a preselected temperature, such as 100° C. to assist in cooling the vehicle component. In this example, the die assembly may include thermal elements to thermos-stabilize, e.g. increase or decrease temperature, the die surface. The quench time, die surface temperature, and applied pressure may be based on a blank thickness. In one example in which the blank has a thickness of approximately 1.6 mm and the die surface temperature is at or below 100° C., the vehicle component formed may be subjected to an approximate five second quench time. In another example in which the die surface temperature is greater than 100° C., the quench time may be increased to a time-period greater than five seconds.

Responsive to detection of the vehicle component having a temperature at or below a predetermined extraction temperature, such as 130° C. or less, the vehicle component may be removed from the die assembly in operation 162. In one example, a temperature sensor may be in thermal communication with the vehicle component to monitor thermal conditions thereof. The temperature sensor may be embedded within the vehicle component or may be external the vehicle component for contact with a surface thereof. The temperature sensor may be in communication with a controller or an indicator to send a notification signal indicating the vehicle component is at or approaching the predetermined temperature, such as an extraction temperature of approximately 130° C. In another example, the thermal sensor may be in communication with an automated removal system to trigger removal of the vehicle component from the die assembly upon detection of the vehicle component at or approaching the predetermined temperature, such as 130°. The extraction temperature may be further based on a forming severity of the vehicle component. The forming severity relates to a complexity of a design of the vehicle component.

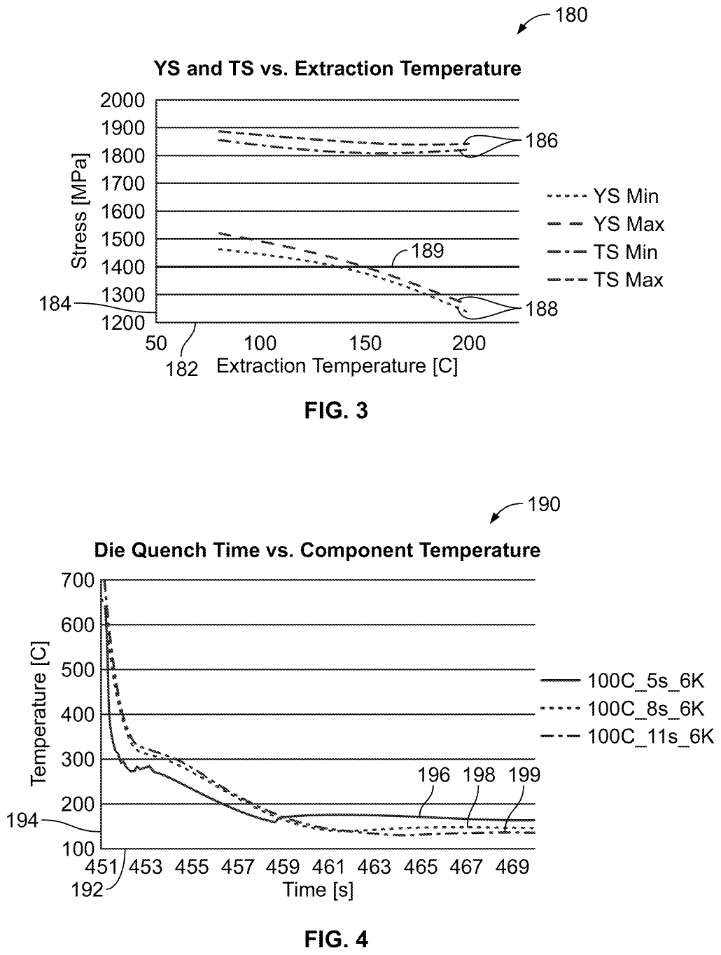

FIG. 3 is a graph illustrating an example of a comparison of yield strength and tensile strength for a portion of a material sample subjected to various extraction temperatures during a hot-stamping process, referred to as a graph 180. The material sample may be Usibor 2000 or a similar material as described herein. In this example, multiple material samples were extracted from a die assembly at various temperatures. An X-axis 182 represents an extraction temperature in Celsius. A Y-axis 184 represents a stress in MPa.

Plots 186 represent a tensile strength minimum and a tensile strength maximum for the material sample relative to respective extraction temperatures. Plots 188 represent a yield strength minimum and a yield strength maximum for the material sample relative to the respective extraction temperatures. Line 189 represents a predetermined stress acceptability value based on desired vehicle component properties. As shown by the graph 180, a yield strength of the material sample drops below line 189 when the extraction temperature is greater than 130° C. Extracting the material sample at a temperature approximately equal to or less than 130° C. provides a desired yield strength.

FIG. 4 is a graph illustrating an example of a comparison of thermos-profiles of a material sample subjected to various die quench time-periods during a hot-stamping process, referred to as a graph 190. The material sample may be Usibor 2000 or a similar material as described herein. In this example, multiple material samples were quenched within a die assembly for various time-periods and a surface of the die assembly was maintained at approximately 100° C. An X-axis 192 represents time in seconds. A Y-axis 194 represents a temperature in Celsius of the material sample.

Plot 196 represents a quench to the material sample of approximately five seconds at 100° C. under a contact pressure of approximately 2 N/mm². Plot 198 represents a quench to the material sample of approximately eight seconds at 100° C. under a contact pressure of approximately 2 N/mm². Plot 199 represents a quench to the material sample of approximately eleven seconds at 100° C. under a contact pressure of approximately 2 N/mm². In each of these examples, the quench time begins at 451 seconds and during 0 seconds to 451 seconds, the material sample is being heated and then transferred to a die assembly. As shown by graph 190, an increased quench time assists in providing a cooler extraction temperature for the material sample.

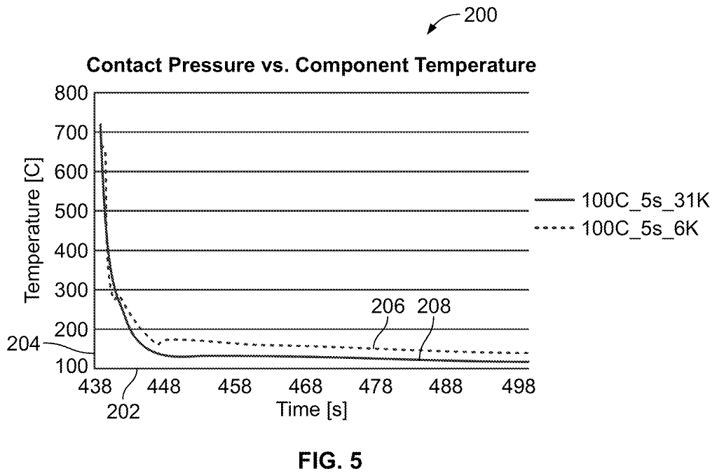

FIG. 5 is a graph illustrating an example of a comparison of thermos-profiles of a material sample subjected to various pressure applications during a hot stamping process, referred to as a graph 200. The material sample may be Usibor 2000 or a similar material as described herein. In this example, multiple material samples were subjected to various contact pressures within a die assembly over predetermined time-periods. An X-axis 202 represents time in seconds. A Y-axis 204 represents temperature in degrees Celsius.

Plot 206 represents a contact pressure of 10 N/mm² applied to the material sample. Plot 208 represents a contact pressure of 2 N/mm² applied. As shown in 200, increasing a contact pressure of the die assembly to the material sample assists in providing a lower extraction temperature for the material sample.

As shown in FIGS. 4 through 5, a blank or vehicle component may be subjected to various process variables to assist in achieving a desired yield strength of the blank or component. Various extraction temperatures, quench times, and/or contact pressures may influence microstructure transitions to achieve a final vehicle component having the desired yield strength.

While various embodiments are described above, it is not intended that these embodiments describe all possible forms encompassed by the claims. The words used in the specification are words of description rather than limitation, and it is understood that various changes can be made without departing from the spirit and scope of the disclosure. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for forming a vehicle component comprising:
heating a blank of 36MnB5 in a furnace to an austenitization temperature;
stamping the blank with a die assembly to form a vehicle component and change a microstructure of the blank from austenite to martensite; and
responsive to a temperature of the vehicle component being at or below 130° C., removing the vehicle component from the die assembly such that the vehicle component has a yield strength equal to or greater than 1400 MPa.

2. The method of claim 1, wherein the blank is micro-alloyed with Niobium, Titanium, Molybdenum, and Chromium and coated with AlSi10Fe3.

3. The method of claim 1, wherein the blank is retained within the die assembly for a quench time of between five and eleven seconds following the stamping.

4. The method of claim 3 further comprising thermo-stabilizing a surface of the die assembly to a predetermined temperature.

5. The method of claim 4, wherein the predetermined temperature is approximately 100° C.

6. The method of claim 1, wherein the stamping further comprises applying a pressure of approximately 10 N/mm² to the blank.

7. The method of claim 6 further comprising thermo-stabilizing a surface of the die assembly to 100° C. or less prior to stamping the blank and subjecting the vehicle component to an approximate five second quench time.

8. The method of claim 1, wherein the blank is Usibor 2000.

9. A method for forming a vehicle component
comprising: heating a blank within a furnace;
stamping the blank with a die assembly at a contact pressure of approximately 10 N/mm² to form a vehicle component; and
removing the vehicle component at or below a temperature of 130° C.,
wherein the contact pressure and the removal at or below 130° C. results in a martensitic microstructure and a yield strength at or greater than 1400 MPa.

10. The method of claim 9, wherein the blank is 36MnB5 micro-alloyed with Niobium, Titanium, Molybdenum, and Chromium and coated with AlSi10Fe3.

11. The method of claim 10, wherein the blank is Usibor 2000.

12. The method of claim 9 further comprising quenching the vehicle component within the die assembly for a time-period of between five and eleven seconds.

13. The method of claim 12, wherein the contact pressure of approximately applied to the blank reduces a temperature of the vehicle component to 130° C. or less.

14. A method for forming a vehicle component comprising:
heating a blank to a predetermined temperature in a furnace;
transferring the blank to a die assembly;
stamping the blank within the die assembly at a contact pressure of approximately 10 N/mm² to form a vehicle component;
quenching the formed vehicle component within the die assembly for a time-period of between five and eleven seconds; and
responsive to a temperature of the vehicle component being at or below 130° C., removing the vehicle component from the die assembly such that the vehicle component has a fully martensitic microstructure and a yield strength equal to or greater than 1400 MPa when removed from the die assembly.

15. The method of claim 14 further comprising thermo-stabilizing a surface of the die assembly to a predetermined temperature prior to stamping the blank.

16. The method of claim 15, wherein the predetermined temperature is approximately 100° C.

17. The method of claim 15, wherein the surface of the die assembly is thermo-stabilized for approximately thirty minutes prior to performing the quenching operation.

18. The method of claim 15, wherein the blank has an approximate 1.6 mm thickness.

19. The method of claim 14, wherein the blank is 36MnB5 micro-alloyed with Niobium, Titanium, Molybdenum, and Chromium, and coated with AlSi10Fe3.

20. The method of claim 14, wherein the blank is Usibor 2000.
